(19) United States
(12) Patent Application Publication
(10) Pub. No.: US 2002/0062446 A1
(43) Pub. Date: May 23, 2002

(54) Apparent data erasure method

(76) Inventors: Tzu-Feng Tseng, Hsinchu Hsien (TW); Wen-Rei Guo, Chiayi Hsien (TW); Yung-Cheng Hsieh, Kou-Hu Shiang (TW)

Correspondence Address: J.C. PATENTS, INC., 4 Venture,, Suite 250, Irvine,, CA, 92618, US

(21) Appl. No.: 09/767,339

(22) Filed: Jan. 23, 2001

(30) Foreign Application Priority Data
Nov. 17, 2000 (TW) 89124360

(51) Int. Cl. G06F 12/14; H04L 9/32

(52) U.S. Cl. 713/200

(57) ABSTRACT

An apparent data erasure method for an optical disk. The content of a first data content table and the content of a second data content table are stored in the boot region of the optical disk. By removing the data in the a second data content table from the data in the a first data table, only a portion of the data in the data-recording region of the optical disk is displayed.

### CROSS-REFERENCE TO RELATED APPLICATION

This application claims the priority benefit of Taiwan application serial no. 89124360, filed Nov. 17, 2000.

### BACKGROUND OF THE INVENTION

1. Field of Invention

The present invention relates to a method of hiding data. More particularly, the present invention relates to a method of hiding data inside an optical disk.

2. Description of Related Art

In general, any data burnt in an optical disk can be read by a disk browser. However, a user who has already written some data on an optical disk may not want to disclose some sensitive information in the optical disk. Hence, the inability of an optical disk to hide important data is a major drawback to the current optical disk system.

### SUMMARY OF THE INVENTION

Accordingly, one object of the present invention is to provide an apparent data erasure method for protecting important information in an optical disk from being accessed and copied.

The apparent data erasure method includes the following steps. Before burning batches of data into an optical disk, a user must divide the boot region of the optical disk into a first sub-boot region and a second sub-boot region. A first data content table is stored in the first sub-boot region while actual data is burnt in the data-recording region of the optical disk. A second data content table is stored in the second sub-boot region.

When another user wishes to access data within the optical disk, authorization for reading the entire disk is obtained from the user. If the user has such an authority, everything within the optical disk is displayed on demand. On the other hand, if the user does not have the authority to access everything inside the optical disk, the data as stipulated in the second data content table held inside the second sub-boot region are removed from the data as stipulated in the first data content table held inside the first sub-boot region. Hence, the user can access only the data in the permitted data-recording region. In other words, the user is able to access the data corresponding to the first data content table after the data corresponding to the second data content table is removed.

The invention also provides an alternative apparent erasure method for protecting important information in an optical disk from being accessed and copied.

The apparent data erasure method includes the following steps. A first user stores the content of a first data content table for holding all the information about actual data to be burned into the optical disk in the boot region of the optical disk. Meanwhile, the first user stores the actual data in the data-recording region of the optical disk. Lastly, the first user also stores the content of a second data content table in the remaining space of the boot region.

When another user wishes to access data within the optical disk, authorization for reading the entire disk is obtained from the user. If the user has such an authority, everything within the optical disk is displayed on demand. On the other hand, if the user does not have the authority to access everything inside the optical disk, the data as stipulated in the second data content table held inside the second sub-boot region are removed from the data as stipulated in the first data content table held inside the first sub-boot region. Hence, the user can access only the data in the permitted data-recording region. In other words, the user is able to access the data corresponding to the first data content table after the data corresponding to the second data content table is removed.

In this invention, a first user is able to delete the data corresponding to the second data content table from the data corresponding to the first data content table before displaying to a second user. Hence, data can be hidden inside an optical disk by a first user to prevent a second user from accessing or copying the data without authorization.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a sketch of an optical disk for implementing the data security system according to a first preferred embodiment of this invention;

FIG. 2 is a flow chart showing the steps for implementing the apparent erasure method according to the first preferred embodiment of this invention;

FIG. 3 is a flow chart showing how a second user may access data within an optical system according to the first preferred embodiment of this invention;

FIG. 4 is a sketch of an optical disk for implementing the data security system according to a second preferred embodiment of this invention;

FIG. 5 is a diagram showing the fields in the boot region of the optical disk according to the second preferred embodiment;

FIG. 6 is a flow chart showing the steps for implementing the apparent erasure method according to the second preferred embodiment of this invention; and

FIG. 7 is a flow chart showing how a second user may access data within an optical system according to the second preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

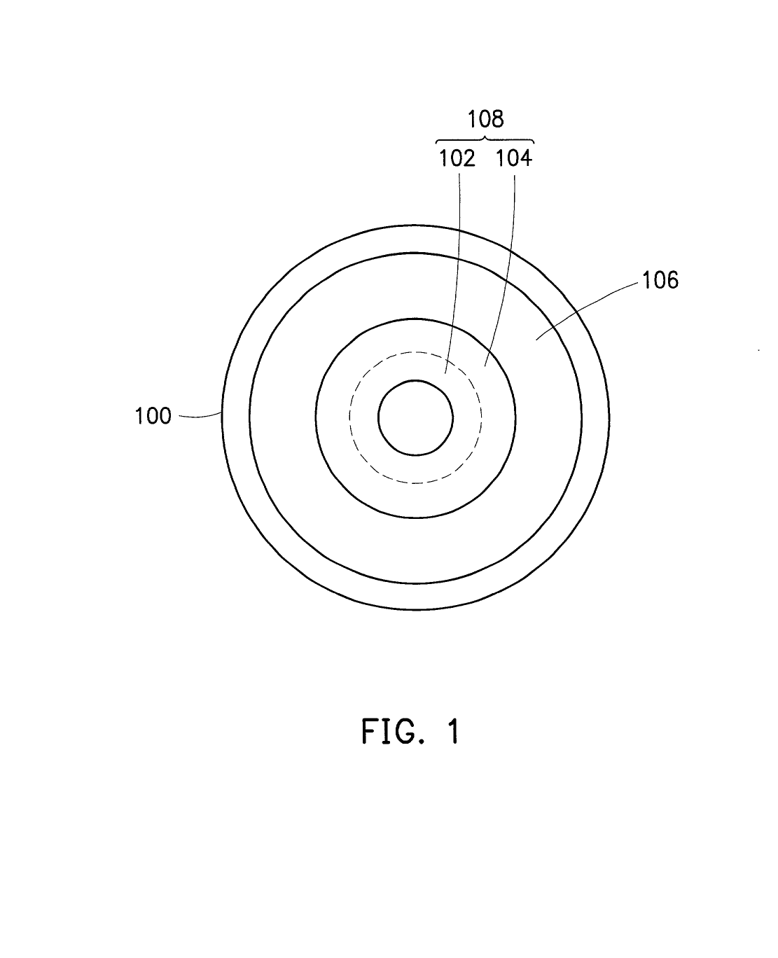

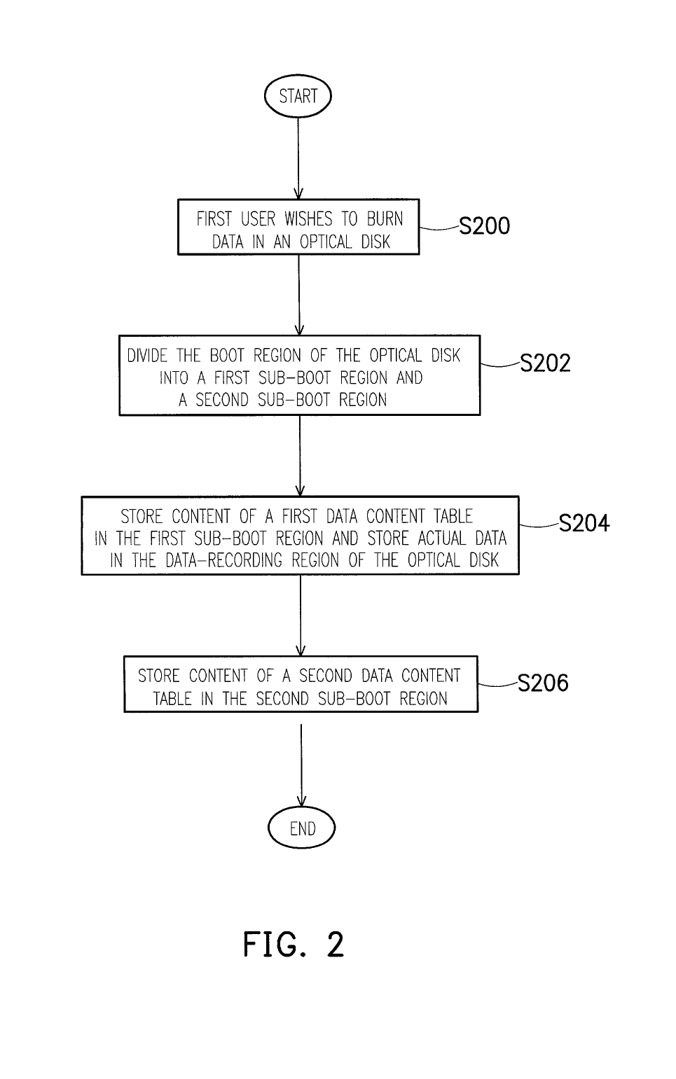

FIG. 1 is a sketch of an optical disk for implementing the data security system according to a first preferred embodiment of this invention. FIG. 2 is a flow chart showing the steps for implementing the apparent data erasure method according to the first preferred embodiment of this invention.

As shown in FIGS. 1 and 2, the apparent data erasure method includes the following steps. In step S202, the original boot region 108 of an optical disk is divided into a sub-boot region 102 and a second sub-boot region 104. In step S204, the content of a first data content table is stored in the first sub-boot region 102. The first data content table holds all the relevant data about the burnt data in the optical disk. Thereafter, batches of data are written down in the data-recording region 106 of the optical disk.

In step S206, the content of a second data content table is stored in the second sub-boot region 104 of the optical disk. The second data content table holds a portion of the related data for accessing the recorded data in the optical disk. The first data content table and the second data content table holds related data for accessing the burnt data. The related data include data addresses, data lengths and data attributes. The burnt data in the optical disk includes document data, image data or photographic data.

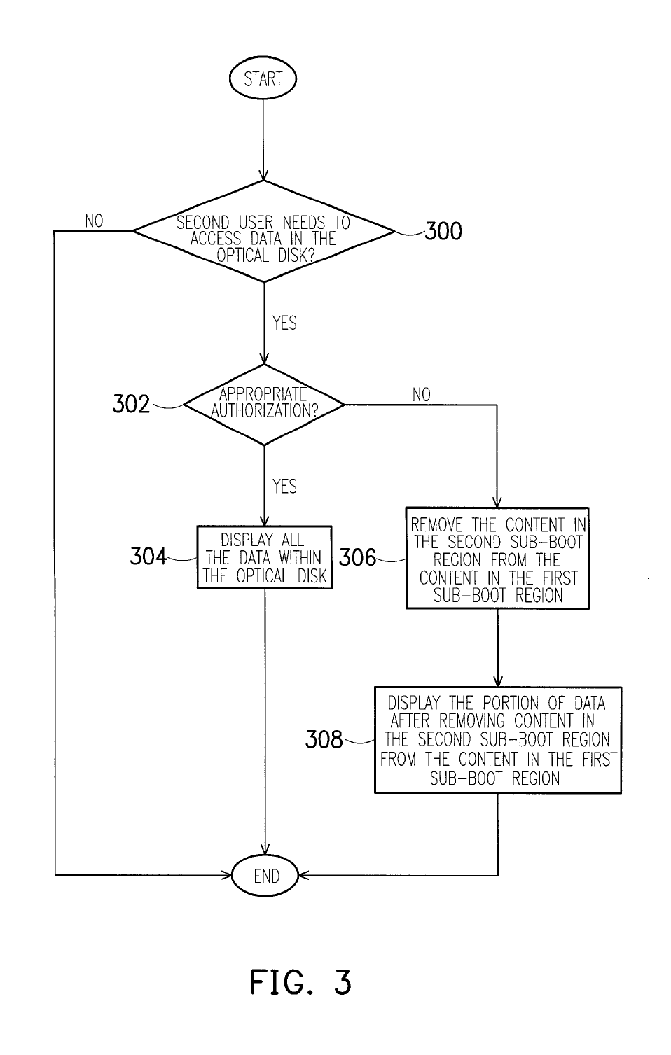

FIG. 3 is a flow chart showing how a second user may access data within an optical system according to the first preferred embodiment of this invention. In step S300, a second user wishes to access data on an optical disk previously recorded by a first user. In step S302, authority of the second user is checked. If the second user is found to have the authority to access the data in the entire optical disk, permission to access the data is granted in step S304. On the other hand, if no valid authorization can be provided by the second user, a portion of the data is removed in step 306 before displaying the remaining data on the optical disk to the second user in step S308.

Data that correspond to the second data content table are removed from the first data content table in step S306. Hence, in the subsequent step S308, the second user can only access the data within the optical disk that corresponds to the first data content table, excepting the portion specifically mentioned in the second data content table.

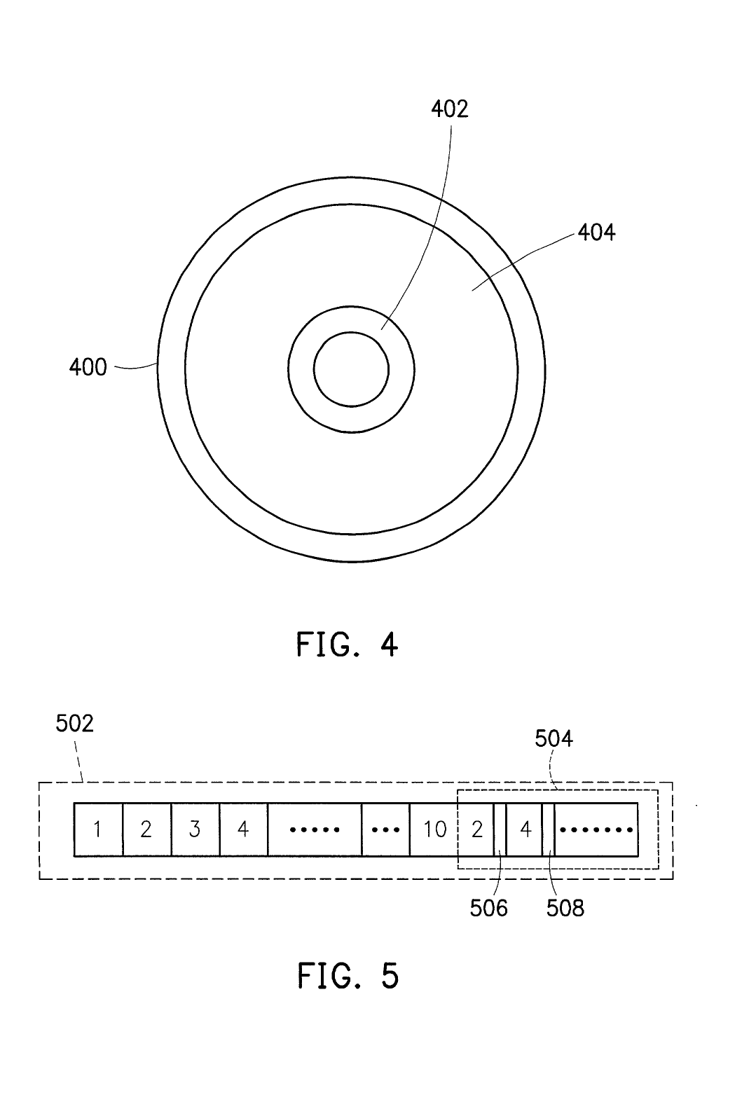

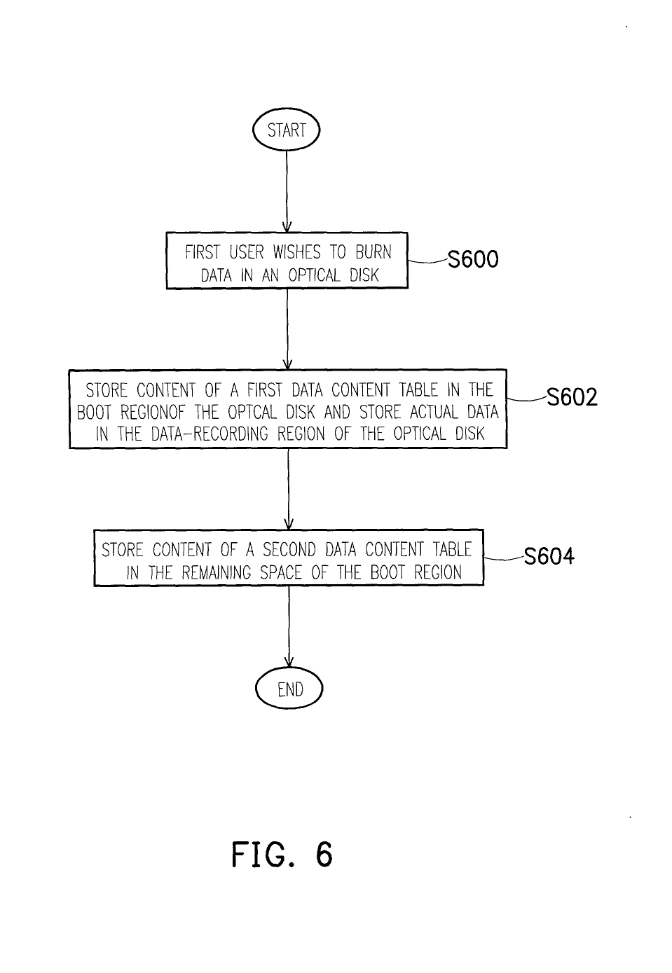

FIG. 4 is a sketch of an optical disk for implementing the data security system according to a second preferred embodiment of this invention. FIG. 5 is a diagram showing the fields in the boot region of the optical disk according to the second preferred embodiment. FIG. 6 is a flow chart showing the steps for implementing the apparent erasure method according to the second preferred embodiment of this invention. As shown in FIG. 6, the apparent data erasure method includes the following steps. In step S600, a first user wishes to store batches of data such as documents, images and photographic imprints into an optical disk 400. In step S602, information regarding such data is stored in a first data content table 502 on the boot region 402 of the optical disk 400. Actual data are next burnt in the data-recording region 404 of the optical disk. The first data content table 502 records all information about the actual data on the optical disk including data addresses, data length and data attributes.

Content of the second data content table 504 is stored in the remaining boot region 402 of the optical disk 400 in step S604. In fact, content of the second data content table 504 is stored in the space within the boot region 402 immediately after the region for storing the content of the first data content table 502. The second data content table holds data attributes of a portion of the data such as attributes of data to be hidden in field positions 506 and 508. In addition, the second data content table also records information about the actual data including data addresses, data length and data attributes of a portion of the data.

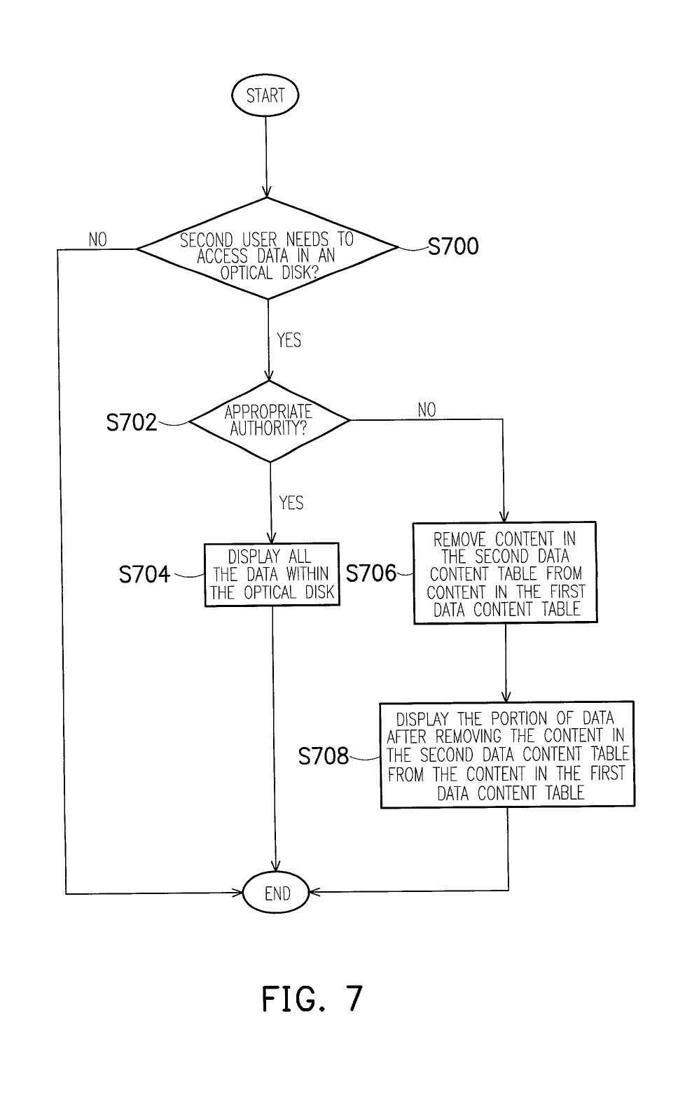

FIG. 7 is a flow chart showing how a second user may access data within an optical system according to the second preferred embodiment of this invention.

In step S700, a second user wishes to access data on an optical disk previously recorded by a first user. In step S702, authority of the second user is checked. If the second user is found to have the authority to access the data in the entire optical disk, permission to access the data is granted in step S704. On the other hand, if no valid authorization can be provided by the second user, a portion of the data corresponding to the content of the second data content table is removed from the data corresponding to the content of the first data content table in step S706.

Information stored inside the first data content table includes related attributes of all the data in the optical disk. The related attributes include data addresses, data lengths and data attributes. Content of the second data content table is stored in the remaining area of the boot region of the optical disk. The second data content table holds a portion of the related attributes of the actual data including data addresses, data lengths and data attributes of a portion of the actual data in the optical disk. In fact, the second data content table holds data attributes of a portion of the data to be hidden from another user.

In step S708, only a portion of data on the optical disk is accessible by the second user. The portion of data that can be accessed by the second user includes the data corresponding to the first data content table after removing the data corresponding to the second data content table. Content of the second data content table is stored in the remaining space of the boot region after content of the first data content table is stored inside the boot region of the optical disk.

In summary, one major advantage of the invention is the prevention of a second user from accessing or copying of data written by a first user on an optical disk without authority.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparent data erasure method related to the protection of written data in an optical disk by a first user from unauthorized accessing or copying by a second user, comprising the steps of:
dividing the boot region of an optical disk into a first sub-boot region and a second sub-boot region;
storing up the content of a first data content table in the first sub-boot region;
storing up the actual data in the data-recording region of the optical disk; and
storing up the content of a second data content table in the second sub-boot region;
wherein the first data content table holds all related data for accessing the actual data while the second data content table holds only a portion of the information for accessing a portion of the actual data.

2. The method of claim 1, wherein actual data includes document data, image data and photographic data.

3. The method of claim 1, wherein the related data includes a plurality of data addresses, a plurality of data lengths and a plurality of data attributes.

4. An apparent data erasure method related to the capability of a second user to access only the non-hidden data in an optical disk, comprising the steps of:
removing the data corresponding to a second data content table from the data corresponding to a first data content table, wherein content of the first data content table is stored in a first sub-boot region of the optical disk while content of the second data content table is stored in a second sub-boot region of the optical disk;
displaying of the remaining data in a data-recording region that corresponds to the first data content table; and
permitting a second user to access data in the displayable data recording-region.

5. The method of claim 4, wherein the actual data includes document data, image data and photographic data.

6. The method of claim 4, wherein before the step of permitting the second user to access data in the optical disk, further includes the following treatments:
finding the authority level of the second user;
permitting the second user to access all the data within the optical disk if the second user has appropriate authority; and
displaying only a portion of the data in the optical disk if the second user does not have appropriate authority to read the entire disk.

7. The method of claim 4, wherein the first data content table records all the related data for accessing any data within the optical disk.

8. The method of claim 4, wherein the second data content table records a portion of the related data for accessing a portion of the data in the optical disk.

9. The method of claim 7 or claim 8, wherein the related data includes a plurality of data addresses, a plurality of data lengths and a plurality of data attributes.

10. An apparent data erasure method related to the protection of written data in an optical disk by a first user from unauthorized accessing or copying by a second user, comprising the steps of:
dividing the boot region of an optical disk into a first sub-boot region and a second sub-boot region;
storing up the content of a first data content table in the first sub-boot region;
storing up the actual data in the data-recording region of the optical disk;
storing up the content of a second data content table in the second sub-boot region;
removing the content in the second data content table from the content in the first data content table;
displaying the content of the first data content table after removing the content in the second data content table;
searching out the data in the data-recording region that corresponds to the remaining content in the first data content table; and
permitting the second user to access the data in the data-recording region that corresponds to the remaining content in the first data content table.

11. The method of claim 10, wherein the actual data includes document data, image data and photographic data.

12. The method of claim 10, wherein before the step of permitting the second user to access data in the optical disk, further includes the following treatments:
finding the authority level of the second user;
permitting the second user to access all the data within the optical disk if the second user has appropriate authority; and
displaying only a portion of the data in the optical disk if the second user does not have appropriate authority to read the entire disk.

13. The method of claim 10, wherein the first data content table records all the related data for accessing any data within the optical disk.

14. The method of claim 10, wherein the second data content table records a portion of the related data for accessing a portion of the data in the optical disk.

15. The method of claim 13 or claim 14, wherein the related data includes a plurality of data addresses, a plurality of data lengths and a plurality of data attributes.
